(19) United States
(12) Patent Application Publication
(10) Pub. No.: US 2012/0076961 A1
(43) Pub. Date: Mar. 29, 2012

(54) FINE MATT PRINTING PAPER AND ITS METHOD OF PREPARATION

(75) Inventor: Jean Marie Baumlin, Anzin Saint-Aubin (FR)

(73) Assignee: ARJO WIGGINS FINE PAPERS LIMITED, Manchester (UK)

(21) Appl. No.: 13/259,723

(22) PCT Filed: Mar. 23, 2010
(86) PCT No.: PCT/FR10/00246

§ 371 Date: Oct. 21, 2011

(30) Foreign Application Priority Data
Apr. 1, 2009 (FR) 0901598

(51) Int. Cl. B41M 5/50

(52) U.S. Cl. 428/32.11

(57) ABSTRACT

Fine matt writing and/or printing paper, in particular for offset printing, including on at least one of its faces a coating that comprises pigments and a binder, the pigments comprising silica with particles having a mean diameter greater than or equal to 3 μm, and with the quantity that is deposited per unit area of the coating being greater than 0.4 g/m² and less than 1.5 g/m² or in which the quantity of silica is alternatively or in combination greater than 6% and less than 15%, and in particular less than 10% by dry weight relative to the total dry weight of the coating, the paper having on said face a degree of gloss before printing that is less than 3.5% as measured at 75° using the Tappi®T480 standard.

The present invention relates to fine matt writing and/or printing paper, in particular for offset printing, also referred to as graphic paper, with a short drying time for writing and/or printing inks, and it also relates to the method of preparing the paper. The fine paper may be used in numerous fields, such as art publishing, writing, packaging, etc.

In the printing paper industry, it is possible to distinguish between different purposes for different kinds of paper, each purpose corresponding to users having one particular type of printer and corresponding to a specific market. A client of the papermaking industry thus selects from the various papers on offer the paper that is suitable for printing using the type of printer that is to be used and that corresponds best to the client's needs in terms of quality and cost.

Numerous types of printer or printing exist, including desktop ink-jet printers, continuous ink-jet printers, black and white offset printers (e.g. for printing newspapers), 4-color offset printers (four-color process printers), digital offset printers, thermal offset printers, electrophotographic printers (photocopiers, laser printers), photogravure printers, silkscreen printers, and sublimation printers.

The inks used for printing on a given type of paper depend on the type of printing. Inks for ink-jet printing include volatile solvents or water as a vehicle, whereas inks for offset printing make use of vegetable oils or petroleum distillates as a vehicle.

For 4-color offset printing, two types of paper may be used: so-called “coated” papers and fine papers.

A coated paper comprises a conventional paper having a coating deposited thereon that comprises a binder and pigments. The fibers of the paper are thus masked by the coating so that they are no longer visible. The paper serves solely as a medium for supporting the coating, which is designed to impart very good printing quality to the coated paper. The paper constituting the medium of the coated paper is therefore not visible in the final product and may be of relatively poor quality.

A coated paper has a bulk of small value (generally less than 1.04 cubic centimeters per gram (cm³/g)), and the paper pulp used for fabricating it comprises cellulose fibers of more or less good quality, a binder, and a relatively large quantity of fillers (generally greater than 15% by dry weight relative to the total dry weight of the paper).

A coated paper is generally smooth and is usually provided with various levels of gloss, the glossiest coated papers being obtained by calendering. A coated paper typically presents Bekk smoothness lying in the range 100 seconds (s) to 3000 s, a degree of gloss lying in the range 11% to 80% approximately (these measurements being performed at 75° using the Tappi®T480 standard). The coating is generally deposited on the paper at a rate of 18 grams per square meter (g/m²) to 35 g/m² per face and comprises inexpensive pigments such as calcium carbonates.

The coating is usually deposited on the paper using a smoothing coating technique such as a blade that imparts flatness to the coated paper that masks the imperfections of the paper such as the formation and the roughness contributed by the mat of fibers.

Coated paper is produced at lower cost using machines presenting a width of several meters and operating at sheet winding speeds that are typically greater than 1000 meters per minute (m/min). The paper firstly receives sizing which is a first layer of coating that is generally pigmented and deposited in line at a rate of a few g/m², then receives the above-mentioned pigmented coating that defines the printability of the final product, and is then calendered at the end of the line.

It has been found that the greater the size of the particles constituting the pigments of the coating of a coated paper, the greater the mattness of the coated paper, but also the longer the drying time of printing inks. The pigments used therefore generally have a particle size that is relatively small (of micrometer order, while on the contrary the quantity of particles in the coating is relatively large.

In contrast, a fine paper is high-quality paper that differs from a conventional paper or medium used for preparing a coated paper in particular in terms of its bulk, the composition of the papermaking pulp that is used in its fabrication, and its cost of fabrication, which is higher. A fine paper is generally “marked” or “textured” naturally as a result of the fabrication method used and/or as a result of treatment that is applied thereto such as graining.

A fine paper generally presents a bulk that is greater than or equal to 1.10 cm³/g, and the papermaking pulp that is used in its fabrication comprises cellulose fibers of good quality, a binder, and a small proportion of fillers and/or additives, such as starch.

A fine paper is considered as being matt when its degree of gloss is of the order of 4% to 8%, and as glossy when its degree of gloss is of the order of 10% to 20% (these measurements being performed at 75° using the Tappi®T480 standard). A glossy fine paper has a degree of gloss that is equivalent to that of a matt coated paper, which is why a fine paper generally appears to be more matt than a coated paper.

An important characteristic of a fine paper is its printability, and in particular the drying time of the ink used for printing thereon. When a fine paper is printed, e.g. by an offset printing method, it is important for the drying time of the inks that are used to be relatively short so that the inks printed on the recto face of a piece of fine paper do not mark the verso face of another piece of fine paper when they are stacked on one another, or of the same piece of fine paper when it is rolled up.

The fine papers used in 4-color offset printing are mostly not treated. Inks are deposited directly on the fibers, which are covered in no more than the usual additives. Under such circumstances, the paper does not have any pigments at its surface and the fibers of the paper are visible and can clearly be seen after printing. The visible textured appearance of the fine paper imparts relief to its printed surface and gives rise to a final appearance, after printing on the fine paper, that is very attractive, and greatly appreciated by users. Another considerable difference between a fine paper and a coated paper is that when a coated paper presents a certain amount of surface roughness, that is due to the coating deposited on the paper, whereas the surface roughness of a fine paper is due essentially to its own texture.

A fine paper is generally textured or marked, and its texture may be natural and/or forced, i.e. it may be obtained by a graining or marking method or by an analogous method. A fine paper may be grained during fabrication of the paper (e.g. by means of a suitable wire for drying the papermaking pulp or by means of embossing or marking rollers), or thereafter. A grained fine paper includes patterns that are recessed and/or in relief on at least one of its faces, e.g. giving the final product after printing textures such as curved lines or geometrical figures. In contrast, a coated paper has a smooth surface that does not reveal the mat of fibers or any marking of the medium by an element used in the fabrication method. A fine paper may be laid and may include laid lines, e.g. made using a watermarking roller.

Nevertheless, present fine papers suffer from relatively poor printing quality, in particular since the drying times of the inks used are very long. The fibers of fine paper do not fix printing inks sufficiently and therefore they do not enable the inks to dry quickly. Furthermore, the flatnesses are not uniform since they depend on the mat of fibers making up the fine paper, which, by its very structure, is not uniform.

Proposals have already been made to treat fine paper so as to improve its printing qualities while avoiding masking the surface relief of the paper. A treatment coating including pigments and a binder is then deposited on a face of the fine paper in order to improve its printability.

By way of example, one solution for reducing the drying times of printing inks on a fine paper consists in using very fine calcium carbonate pigments in the treatment coating, with particles having a size that is less than 1 micrometer (μm). Nevertheless, that solution is not very satisfactory since it gives rise to an increase in the gloss of the fine paper. In contrast, the use of coarse calcium carbonate pigments (presenting particles with a size greater than 2 μm) makes the fine paper more matt but increases the drying times of printing inks and gives rise to dusting on the blanket during offset printing.

A particular object of the present invention is to improve the printability of fine paper, in particular for offset printing, while preserving its texture, and increasing its mattness so that the fine paper presents a degree of gloss that is less than about 4% before printing or less than about 7% after printing. The degree of gloss of a fine paper that has been printed is in general greater than the degree of gloss of the same paper before printing.

Concerning the printability of fine paper, the invention seeks in particular to reduce the drying times of inks (e.g. deposited by an offset method), which times are about 3 hours (h) for a non-treated fine paper at present. Another object of the invention is to improve or control other printing characteristics of fine paper, such as mottling, ink density, contrast, and dusting. “Mottling” is the term given to the lack of uniformity of printing, and it is evaluated by eye or using a camera observing a 100% black or blue flat tint print. “Dusting” is the name given to the appearance of powder on the blanket during offset printing, where this defect is associated with poor adhesion of the treatment coating on the paper. If dusting is excessive, the printer needs to stop the machine in order to clean it before restarting printing, thereby losing time, which is expensive.

To this end, the invention provides a fine matt writing and/or printing paper, in particular for offset printing, the paper having a bulk greater than or equal to 1.10 cm³/g and including, on at least one of its faces, a coating comprising pigments and a binder, the paper being characterized in that the pigments comprise silica having particles with a mean diameter greater than or equal to 3 μm, and deposited at a quantity per unit area of the coating that is greater than 0.4 g/m² and less than 1.5 g/m², said paper having on said face a degree of gloss before printing that is less than or equal to 4% when measured at 75° using the Tappi®T480 standard.

In a particular embodiment, the fine paper as treated in this way presents a printing mean drying time of less than 20 minutes (min), preferably less than 15 min.

The definition of a fine paper and the differences between a fine paper and a conventional paper or a coated paper are set out above. The fine paper of the invention presents a bulk that is greater than or equal to 1.10 cm³/g, preferably greater than 1.2 cm³/g, and for example greater than 1.25 cm³/g. It presents thickness lying in the range 0.1 millimeters (mm) to 0.5 mm, for example, and preferably lying in the range about 0.15 mm to 0.35 mm, and/or weight lying in the range 100 g/m² to 300 g/m², and preferably in the range 120 g/m² to 240 g/m². The bulk of a fine paper is the ratio of its thickness divided by its weight.

The fine paper of the invention is matt or even ultra-matt since it presents a very low degree of gloss, less than or equal to 4% before printing, whereas prior art fine papers generally present a degree of gloss of about 4%, at best. The degree of gloss of the fine paper of the invention may lie in the range 2% to 4% and preferably in the range 2% to 3%, which corresponds to a degree of gloss for the fine paper after printing that lies in the range 3% to 7% approximately, and preferably in the range 3% to 5%. The degree of gloss of the fine paper before printing is measured at 75° using the Tappi®T480 standard, the printing inks used being 100% black or four colors at 400% (yellow, red, blue, and black, each at 100%).

This low degree of gloss is obtained by depositing a treatment coating on fine paper, the treatment coating including silica pigments having particles of a size that is greater than or equal to 3 μm and deposited at a quantity of more than 0.4 g/m² and less than 1.5 g/m². The silica is used for its gloss-removing qualities so as to reduce the gloss of the fine paper before and after printing, where the gloss-removing qualities of silica particles is due to their size and/or to their cellular or porous structure that diffuses light.

The invention that is defined above with reference to the quantity of silica deposited per unit area of the treatment coating may alternatively or in combination be defined with reference to the quantity of silica contained in the coating as determined in terms of dry weight relative to the total dry weight of the layer. Thus, the treatment coating includes silica pigments with particles of a size greater than or equal to 3 μm and at a quantity of more than 6% and less than 15% (in particular less than 10%) by dry weight relative to the total dry weight of the coating.

The size of the silica particles in the invention is relatively large, in particular compared with the size of the pigments used, which size is of micrometer order. The silica particles may have a mean diameter greater than 6 μm, and less than 15 μm or 20 μm, for example. These particles may also have a mean diameter lying in the range 3 μm to 20 μm, preferably in the range 5 μm to 18 μm, more preferably in the range 7 μm to 15 μm, and for example of the order of 8 μm to 10 μm.

By way of example, the silica used is a porous amorphous synthetic silica such as that sold by the supplier Grace under the trademark Syloid ED5®.

The quantity of silica in the coating is relatively small, but it is nevertheless sufficient to improve the performance of the paper during printing, in particular offset printing. The invention serves in particular to reduce significantly the drying times of printing inks, where such times are less than 20 min, and may be less than 15 min or even less than 10 min for fine papers treated in accordance with the invention. This is due in particular to the porosity of the silica particles, which particles are capable of absorbing the fatty compounds that are used as a vehicle for printing inks. Furthermore, because the size of the silica particles is relatively large, these particles contribute to avoiding mixing between pigmented layers containing inks when the inks are put into contact with one another during printing. The silica particles then act as spacers, thereby shortening the drying times of the inks. In a particular embodiment of the invention, the mean diameter of the silica particles is greater than or equal to the thickness of the treatment coating so as to reinforce this spacer property.

Furthermore, since silica particles are relatively expensive, the presence of these pigments in small quantity in the treatment layer gives rise to little extra cost in the fabrication of fine paper.

The layer deposited on the fine paper may include other pigments, e.g. selected from calcium carbonates, kaolins, titanium dioxide, talc, and mixtures thereof. Calcium carbonates are preferably the majority pigments in the treatment coating. The quantity of calcium carbonates in the coating may lie in the range 60% to 90%, and preferably in the range 70% to 85% by dry weight relative to the total dry weight of the coating. By way of example, the calcium carbonates used may be those sold by the supplier Imerys under the trademarks Carbital 75® and Carbital 95®. These calcium carbonates are mixtures of calcium carbonates, Carbital 75® having 75% calcium carbonates with a particle size that is less than 2 μm and Carbital 95® having 95% calcium carbonate particles with a size of less than 2 μm.

Preferably, the treatment coating is free of aluminum oxide or of aluminum hydroxide.

The binder of the treatment coating may be selected from polyvinyl alcohols (PVA), styrene-butadiene or styrene-acrylic copolymers (used in particular in latex form), and mixtures thereof. The coating may have a quantity of PVA and/or of latex lying in the range 7% to 13%, and preferably in the range 8% to 12%, e.g. of the order of 11%-12% by dry weight relative to the total dry weight of the layer.

The treatment coating may also include a rheology modifier such as a thickener, a curing agent, and/or a surfactant. The coating may include a quantity of curing agent lying in the range 0.2% to 0.6%, preferably in the range 0.3% to 0.5%, and may for example be about 0.4% by dry weight relative to the total dry weight of the coating. It may include a quantity of surfactant lying in the range 0.1% to 0.5%, preferably in the range 0.2% to 0.4%, e.g. being about 0.3% by dry weight relative to the total dry weight of the coating. It may include a quantity of thickener lying in the range 0.5% to 1% and preferably in the range 0.6% to 0.8% by dry weight relative to the total dry weight of the coating. The thickener may be carboxyl methyl cellulose.

The weight of the treatment coating on said face may lie in the range 3 g/m² to 18 g/m², preferably in the range 7 g/m² to 13 g/m², and for example is about 10 g/m².

The treatment coating may have thickness lying in the range 2 μm to 10 μm, and for example it may be of the order of about 5 μm.

The quantity of silica in the coating is greater than or equal to 6%, and in particular 7%, and in particular it lies in the range 6% to 15%, or in the range 6% to 10%, and may lie in the range 7% to 9%, preferably in the range 7.5% to 8.5%, and is for example about 8%, by dry weight relative to the total dry weight of the coating.

The weight of silica on said face lies in the range 0.4 g/m² to 1.5 g/m² and preferably lies in the range 0.5 g/m² to 1.35 g/m².

The fine paper of the invention is preferably made of cellulose fibers, a binder, and fillers presenting a quantity of less than 22%, and preferably less than 15% by dry weight relative to the total dry weight of the paper. It may also be textured in natural and/or forced manner by a method of the above-described type, and it may include patterns that are in relief and/or recessed, the treatment coating modifying said texture on said face little or not at all. In general, these patterns present dimensions of at least a few tens of micrometers.

Prior to treatment, the paper of the invention may present Bendtsen roughness lying in the range 100 milliliters per minute (mL/min) to 1500 mL/min, and preferably in the range 200 mL/min to 1400 mL/min, and/or Bendtsen porosity lying in the range 400 mL/min to 700 mL/min, and preferably in the range 450 mL/min to 600 mL/min, and/or Bekk smoothness lying in the range 1 s to 30 s, and preferably in the range 2 s to 25 s.

The present invention also provides a method of preparing a fine matt writing and/or printing paper as described above, the method being characterized in that it comprises a step consisting in depositing the coating as defined in the present application on at least one of the faces of the fine paper by a contactless type coating method, such as using a curtain, a photogravure cylinder, or an air knife.

Compared with the blade coating technique that flattens the mat of fibers constituting the fine paper by scraping the coating, curtain, photogravure cylinder, and air knife coating techniques do not smooth the fine paper but merely deposit the coating onto the fine paper, with the coating following the texture of the fine paper. The coating deposited by such techniques presents a thickness that is more uniform and the outside surface of the coating is less flat and therefore more marked, thereby contributing to the mattness of the final product and to the final appearance after printing.

The invention can be better understood and other details, characteristics, and advantages of the present invention appear more clearly on reading the following description including several comparative examples and given with reference to the accompanying drawings, in which:

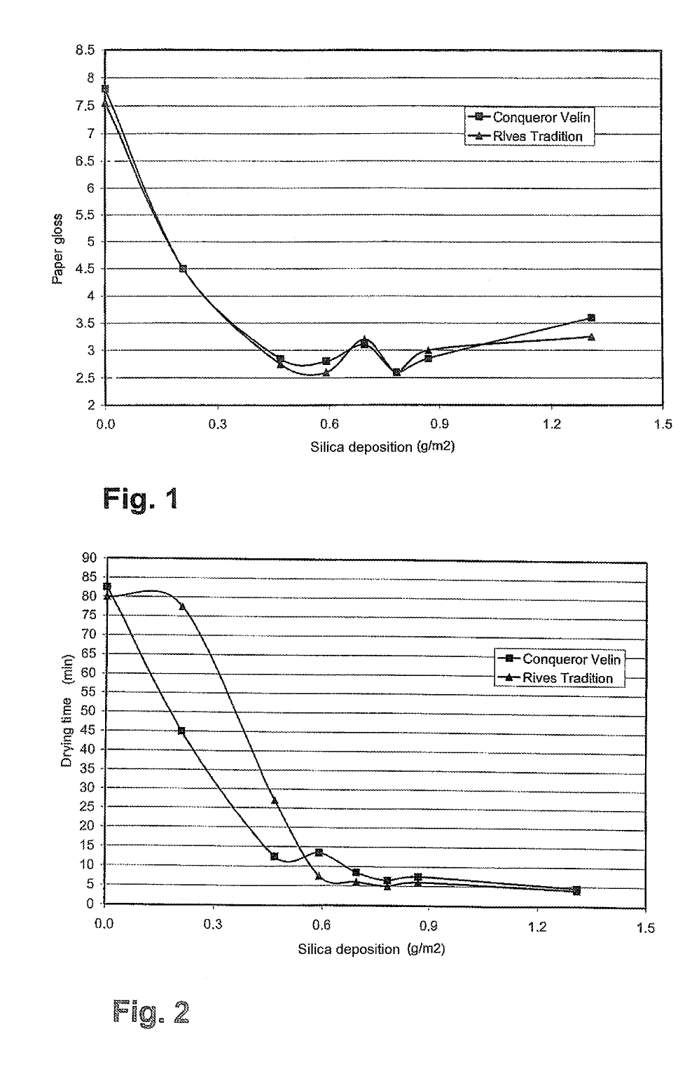

FIG. 1 is a graph showing how the degree of gloss after printing of treated fine paper varies as a function of the quantity of silica deposited by means of the coating;

FIG. 2 is a graph showing how the drying time of printing ink on treated fine papers varies as a function of the quantity of silica deposited by means of the coating;

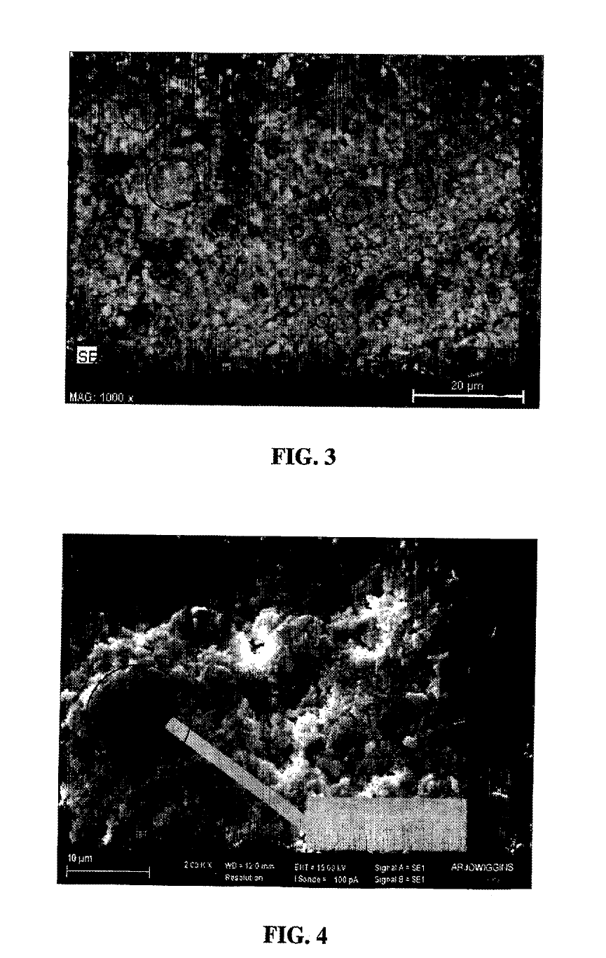

FIG. 3 is an image obtained by means of a scanning electron microscope (SEM) fitted with a system for surface chemical analysis by energy dispersion of X-rays (EDX) and showing the surface of a treated fine paper of the invention; and

FIG. 4 is a scanning electron microscope (SEM) image of the surface of the FIG. 3 treated fine paper shown on a larger scale and in particular showing a particle of silica surrounded by calcium carbonate pigments.

Ten different fine papers, including treated fine papers and non-treated fine papers were tested in order to evaluate their gloss before and after printing, and also the drying times of the printing inks. The table below summarizes the composition of those fine papers and the results obtained in the tests.

The fine papers used were mostly (Examples 1 to 5 and 7 to 10) fine papers sold by the Applicant under the trademarks Conqueror Velin® and Rives Tradition®. Those two fine papers are textured, the first being textured naturally and the second being textured both naturally and in forced manner.

The Rives Tradition® fine paper weighs 240 g/m², presents Bendtsen roughness 1370 mL/min, porosity of 460 mL/min, and Bekk smoothness of 2 s.

Bendtsen porosity or Bendtsen air permeability in compliance with ISO standard 5636-3 is a measure of the quantity of air that passes through a sheet of paper under given conditions, the measurements being expressed in mL/min. The wider open the paper, the greater its porosity, and thus the higher the value of its Bendtsen porosity.

Bekk smoothness is a measure of the time needed to enable a given volume of air to flow between the paper and a surface of glass in contact with the paper (in compliance with ISO standard 5627). The rougher the paper, the more easily air passes via gaps at the surface of the paper (where such gaps are associated with roughness) and the shorter the length of time taken by the air to pass. The smoother the paper, the greater the length of time needed for the air to pass.

Conqueror Velin® fine paper weighs 120 g/m², presents Bendtsen roughness of 200 mL/min, porosity of 580 mL/min, and Bekk smoothness of 21 s. The Conqueror Velin® fine paper weighs half as much as the Rives Tradition® fine paper, and presents greater porosity than Rives Tradition® fine paper. Furthermore, Conqueror Velin® fine paper is less rough and more smooth than Rives Tradition® fine paper, which means that Conqueror Velin® fine paper is less textured than Rives Tradition® fine paper.

In Example 6, a textured fine paper was used that weighs 115 g/m².

Examples 1 and 2 relate to fine papers, Rives Tradition® for the first and Conqueror Velin® for the second, but that were not treated, i.e. that were not covered in a treatment coating.

The other examples (3 to 12) relate to treated fine papers, i.e. including a treatment coating based on pigments and a binder, on at least one of their faces.

In Example 3, the treatment layer comprised as pigments solely kaolin, with 60% thereof having a particle size of less than 2 μm. That treatment coating therefore did not have any silica. The binder of the coating was styrene-acrylic, and the coating also included a synthetic thickener. The treatment coating was deposited by the air knife technique on the fine paper at a rate of 8 g/m² per face.

The fine papers of Examples 4 to 12 were all covered in a treatment coating including silica, which was constituted by that sold by the supplier Grace under the trademark Syloid ED5®. It comprises particles of porous amorphous synthetic silica having size lying in the range 8.4 μm to 10.2 μm and the volume of its porosity is 1.8 milliliters per gram (mL/g).

The treatment coatings of Examples 4 to 12 all contained calcium carbonates, which were the majority pigments in the coating, a binder, a curing agent, and a thickener in Examples 4 to 5 and 7 to 12. The coating of Example 6 also included a surfactant.

The calcium carbonates were mixtures of two types of calcium carbonate, the first being the calcium carbonate sold by the supplier Imerys under the trademark Carbital 75® and the second being calcium carbonate sold by the same supplier under the trademark Carbital 95®. The calcium carbonates were mixed in determined proportions so as to obtain calcium carbonate mixtures in which 80% of the grains presented a size less than 2 μm in Examples 4 to 8 and 10, and 90% presented particles of a size less than 2 μm in Example 9.

In Examples 4 to 10, the binder was a mixture of styrene-butadiene latex or styrene-acrylic with polyvinyl alcohol. The curing agent was an aqueous solution of zirconium ammonium carbonate. The thickener used in Examples 4 to 5 and 7 to 12 was carboxyl methyl cellulose. The surfactant in Example 6 was a non-ionic surfactant of the Gemini® type.

In Examples 4 to 12, the treatment coatings were deposited on the fine papers at a rate of 8 g/m² to 12.5 g/m² per face, with the coatings in Examples 4-5 and 7-10 being deposited with an air knife and the coating of Example 6 being deposited with a curtain.

In Examples 4 to 6, which are comparative examples, the quantity of silica was less than 6% by dry weight relative to the total dry weight of the coating, i.e. relative to the combined dry weight of all of the pigments (silica and calcium carbonates) of the coating plus the dry residues of the binder and the curing agent, and of the thickener and the surfactant, if any.

In contrast, in Examples 7 to 12, which illustrate the present invention in non-limiting manner, the quantity of silica was greater than 6% by dry weight relative to the total dry weight of the coating.

Three tests were performed on the fine papers of Examples 1 to 12. The first test consisted in measuring the degree of gloss of each fine paper (treated or not treated) before printing. The degree of gloss was measured at 75° using the Tappi®T480 standard, which is described briefly below.

The degree of gloss of a fine paper is measured using a reflectometer that records the quantity of light reflected by the surface of the fine paper, with the angles of illumination and reflection being 75° to a normal to said surface. The D-4553 appliance from BYK Gardner is initially calibrated using a black glass plate.

The second test consisted in measuring the drying time of the printing inks on each fine paper, after the paper had been printed using an offset method. In practice, drying time is determined by putting a fine paper face that has been 400% printed (i.e. with four colors: yellow, red, blue, and black, each at 100%) into contact with a non-printed face of another fine paper using an Erichsen press. The contact area between the fine papers is determined using a disk of the press having a diameter of 25 mm, which disk is pressed against the fine papers using a force of 250 newtons (N) for a duration of 1 s. This test, also known as the “no longer sticky time” test consists in measuring how long it takes for there to be no longer any transfer of ink from one face to the other of the fine papers.

The third and last test consisted in measuring the degree of gloss of each fine paper after printing. This degree of gloss was likewise measured at 75° using the Tappi®T480 standard. The measurement was performed on a fine paper face that had been printed uniformly at 100% with a black ink.

Concerning the gloss of the fine papers before printing, it can be observed that the fine papers that were treated with a coating that included more than 6% silica and/or a quantity of silica deposited per unit area of the coating exceeding 0.4 g/m² and in particular 0.5 g/m² (Examples 7 to 12) presented a degree of gloss lying in the range 2.6% to 3.6%, which is very low, and is therefore particularly advantageous. The non-treated fine papers (Examples 1 and 2) had degrees of gloss of 4.6% to 6.8%, respectively. The fine paper treated with a coating that did not include silica (Example 3) had a degree of gloss of 7.5%, and the fine papers treated with a layer having a quantity of silica well below 6% or a quantity of silica deposited per unit area of the coating of less than 0.4 g/m² (Examples 4 and 6) presented a degree of gloss that was still high, respectively 4.5% and 3.9%. In Example 5, the quantity of silica in the layer was 5.2% and the quantity of silica deposited per unit area of the coating was 0.47 g/m², thereby imparting gloss to the fine paper that was low, being 2.8%. Nevertheless, the drying time for printing inks on that paper was still too long (27 min), as described below.

The gloss of the fine papers after printing lay in the range 3.6% to 6.6% for fine papers of the invention in Examples 7 to 12, and in the range 4.6% to 15.8% for treated and non-treated fine papers in the other examples (1 to 6).

The drying times for inks deposited by offset printing on the non-treated fine papers (Examples 1 and 2) was very long, since it was longer than 3 h. The drying times for printing inks on the fine papers of Examples 3 to 6 lay in the range 27 min to 80 min, which times are therefore still too long. The drying times of the inks on the fine papers of the invention (Examples 7 to 12) lay in the range 4 min to 8 min, which is clearly shorter than 10 min and thus considered as being a drying time that is very short for inks that have been deposited by an offset method.

The results obtained by the air knife coating technique are transposable to the curtain coating technique since those two techniques produce results that are similar, in particular in terms of the surface appearance of the deposited treatment coating. Coating by means of a curtain has the advantage of enabling a treatment coating to be deposited at a faster speed, of up to 1000 m/min or even faster. However, that technique may sometimes require certain coating conditions to be complied with such as adding a surfactant in the treatment coating and establishing a minimum flow rate at the coating head in order to maintain a fluid curtain that is stable.

FIGS. 1 and 2 make it easier to understand the influence of the quantity of silica in the treatment layer for a fine paper on the gloss of said fine paper and on the drying time of printing ink deposited by an offset method on said fine paper.

FIG. 1 is a graph showing how the degree of gloss of treated fine papers (plotted up the ordinate on a scale of 0 to 20%, measured at 75° using the Tappi®T480 standard) varied as a function of the quantity of silica deposited per unit area of the treatment coating (plotted along the abscissa with a scale going from 0 to 1.5 g/m²).

FIG. 2 is a graph showing how the drying times of printing inks on treated fine papers (plotted up the ordinate on a scale of 0 to 90 min and measured using the above-specified method) varied as a function of the quantity of silica deposited per unit area of the treatment layer (plotted along the abscissa with a scale from 0 to 1.5 g/m²).

The fine papers tested for obtaining these figures were Rives Tradition® and Conqueror Velin® papers, each of which had been treated on at least one face with a treatment layer including in particular silica pigments having a particle size greater than or equal to 3 μm. Like the above description, these figures constitute examples and are therefore not limiting.

In FIGS. 1 and 2, the curves relate to Conqueror Velin® fine papers possessing little texture, i.e. fine papers that are naturally textured and that have not been subjected to a marking method, or Rives Tradition® fine papers that are textured, i.e. fine papers presenting texture that is both natural and forced (i.e. papers that have been marked with an appropriate method).

FIG. 1 shows that beyond 0.3 g/m² of deposited silica, the gloss of the fine paper remains less than 4% before printing. This is true both for the textured fine papers (Rives Tradition®) and for the fine papers presenting little texture (Conqueror Velin®). This means that above this threshold of 0.3 g/m², added silica causes the gloss of the fine paper to vary in favorable manner with this continuing up to about 1.5 g/m². It is important to observe that these gloss values correspond to degrees of gloss before the fine papers are printed, e.g. in the range 2.5% to 3%, approximately.

FIG. 1 thus shows that a quantity of silica greater than 0.4 g/m² (and having a particle size greater than or equal to 3 μm) in the treatment coating of the tested fine paper serves to confer a very low degree of gloss to the fine paper (less than 6% for degree of gloss after printing). The other printing characteristics (mottling, optical density, contrast, and dusting) are not modified by adding this quantity of silica in the treatment coating of the fine paper.

The curve for the Conqueror Velin® paper in FIG. 2 shows that up to 1.5 g/m² of silica (having a particle size greater than or equal to 3 μm), the greater the quantity of silica that is deposited by means of the treatment coating on the fine paper having little texturing, starting from 0.4 g/m², the more the decrease in the drying time for printing inks.

The drying times of inks on textured fine papers differ a little from those on fine papers having little texturing. The curve for Rives Tradition® paper in FIG. 2 shows that depositing a quantity of less than 0.25 g/m² of silica pigments presenting a particle size greater than or equal to 3 μm in the treatment layer for the textured fine paper has no significant influence on the drying times of inks. This may be explained by the fact that the silica particles are distributed non-uniformly in the recesses and on the projections of the (irregular) surface of the textured fine paper, and that when these particles are few in number, ink drying time is not constant over the entire surface area and may be longer in certain locations. Nevertheless, as explained above, depositing silica by means of this coating, even in small quantity, reduces the gloss of the fine paper. Above a threshold of about 0.4 g/m², the greater the quantity of silica that is deposited the more the drying time of inks is shortened down to a plateau lying at less that 10 min, which is reached when the quantity of deposited silica is greater than or equal to 0.6 g/m².

These figures serve to explain why the treated fine paper made in above-described Example 5 has very little gloss corresponding to that of fine papers of the invention in Examples 7 to 12, while the drying time for printing inks on that paper is nevertheless still too long.

The fine paper of Example 5 is a textured paper that should therefore be compared with the curves applicable to the Rives Tradition® paper in FIGS. 1 and 2. That fine paper was covered in a treatment coating such that the quantity of deposited silica was 0.47 g/m². As can be seen in FIG. 1, that quantity of silica serves to confer a degree of gloss after printing on the paper that is less than 6%, i.e. a degree of gloss before printing that is less than 3.5%, which corresponds substantially to the results of Example 5 (gloss of the paper before printing 2.8% and after printing 4.6%). The quantity of silica deposited per unit area (0.47 g/m²) while lying in a range that is suitable for the invention, nevertheless does not enable the printing ink drying time to be reduced sufficiently, which time was 27 min.

FIG. 2 shows clearly that for paper of this quality, it is necessary to deposit a quantity of silica per unit area that is greater than or equal to 0.5 g/m² (with a particle size greater than or equal to 3 μm) for the drying time of printing ink deposited on said paper to be less than 20 min. These results correspond with those of above-described Examples 7 and 8 that relate to textured fine papers, each of which was treated with a deposited quantity of silica per unit area greater than 0.5 g/m² and each of which presented printing ink drying times of 7 min and 6 min respectively, i.e. clearly shorter than 20 min.

To conclude, fine papers having little texture (of the Conqueror Velin® type) as tested herein and covered on at least one face in a coating that included a quantity of silica per unit area that is greater than 0.4 g/m² with a particle size that is greater than or equal to 3 μm, presented a degree of gloss after printing that was less than 7% (which corresponds substantially to a degree of gloss before printing of less than 4%), and the drying time for printing inks on those papers was less than 20 min. The textured fine papers (of the Rives Tradition® type) as tested herein and that were covered on at least one face in a coating that included a quantity of silica deposited per unit area greater than 0.4 g/m² with a particle size greater than or equal to 3 μm, presented a degree of gloss after printing of less than 6% (corresponding substantially to a degree of gloss before printing of less than 3.5%). However, in order to ensure that the drying time for printing inks on those textured fine papers is less than 20 min, it is preferable for the quantity of silica that is deposited to be greater than or equal to about 0.5 g/m².

The results of FIGS. 1 and 2 were obtained using a particular type of silica, and on this topic it is important to observe that when a different type of silica is used in the treatment coating, the curves of FIGS. 1 and 2 may be somewhat modified, and in particular the curves corresponding to textured fine paper having texture that is both natural and forced, such that the treatment coating may for example require a quantity of silica to be deposited per unit area that is greater than 0.4 g/m² for example rather than 0.5 g/m², as in the above description, in order to ensure that the drying time of offset printing inks deposited on the fine paper treated with that layer is less than 20 min.

FIGS. 3 and 4 are images obtained by a scanning electron microscope (SEM) showing the surface of the treated fine paper as obtained in above-described Example 7.

In FIG. 3, the microscope was fitted with a system for surface chemical analysis by energy disposition of X-rays (EDX) serving to identify particles of silica on the surface of the fine paper. These particles appear in color in the microscope and they are identified herein by circles for greater clarity. The particles are uniformly distributed over the surface of the fine paper and they are covered in smaller pigments of calcium carbonate, as can be seen more clearly in FIG. 4.

In FIG. 4, there can be seen a silica particle that is surrounded by calcium carbonate pigments, thereby creating a cluster on the surface of the paper. A comparison of these images with the relief of the surface of the treated fine paper shows that the clusters formed by the silica particles and the calcium carbonate pigments coincide with the projections at the surface of the treatment coating. This is due to the fact that in this example the size of the silica particles is greater than the dry thickness of the treatment coating deposited on the fine paper. The above-mentioned clusters thus form projections at the surface of the treatment layer, thereby creating rough relief that is additional to the marked relief of the paper that is due to its own texture. It is important to observe that the dimensions (e.g. greater than 50 μm) of the patterns defined by the texture of the paper are generally greater than the dimensions (less than or equal to 20 μm) of the above-mentioned projections of the treatment coating, and therefore that the treatment coating modifies the texture of the fine paper little or not at all. The rough relief of the treatment layer contributes to diffusing light and thus to reducing the gloss of the treated fine paper. It also contributes to reducing the drying time of printing inks by reducing the contact area involved when measuring this parameter.

| | | Examples | | | | | |
|---|---|---|---|---|---|---|---|
| | | 1 | 2 | 3 | 4 | 5 | 6 |
| Fine paper | | Rives | Conqueror | Rives | Rives | Rives | |
| | | Tradition ® | Velin ® | Tradition ® | Tradition ® | Tradition ® | |
| Characteristics of | Texture | natural + | natural | natural + | natural + | natural + | natural |
| the fine paper | | | forced | | forced | forced | forced |
| | Weight (g/m²) | 240 | 120 | 240 | 240 | 240 | 115 |
| | Bulk (cm³/g) | 1.36 | 1.26 | 1.36 | 1.36 | 1.36 | |
| | Bendtsen roughness | 1370 | 200 | 1370 | 1370 | 1370 | |
| | (ml/min) | | | | | | |
| | Bendtsen porosity | 460 | 580 | 460 | 460 | 460 | |
| | (ml/min) | | | | | | |
| | Bekk smoothness (s) | 2 | 21 | 2 | 2 | 2 | |
| Treatment coating | | NO | NO | YES | YES | YES | YES |

| | | | | | | |
|---|---|---|---|---|---|---|
| Composition of the | Pigments | Silica | | 2.6 | 5.2 | 2.6 |
| treatment coating | | Syloid | | | | |
| | | ED5 ® (%) | | | | |
| | | Calcium | | (80% < | (80% < | (80% < |
| | | Carbonates | | 2 mm) | 2 mm) | 2 mm) |
| | | (%) | | 85.2 | 81.9 | 84.8 |
| | | Kaolin (%) | (60% < | | | |
| | | | 2 mm) | | | |
| | | | 90 | | | |

| | Binder (%) | | | (styrene | (styrene | (styrene | (styrene |
|---|---|---|---|---|---|---|---|
| | | | | acrylic | butadiene | butadiene | butadiene |
| | | | | latex) | latex and | latex and | latex and |
| | | | | 9.7 | polyvinyl | polyvinyl | polyvinyl |
| | | | | | alcohol) | alcohol) | alcohol) |
| | | | | | 11.5 | 11.7 | 11.9 |
| | Curing agent (%) | | | | 0.4 | 0.4 | 0.4 |
| | Thickener (%) | | | (synthetic | (carboxyl | (carboxyl | |
| | | | | thickener) | methyl | methyl | |
| | | | | 0.3 | cellulose) | cellulose) | |
| | | | | | 0.3 | 0.8 | |
| | Surfactant (%) | | | | | | 0.3 |
| Total weight of the coating (g/m²) | | | | 8 | 8 | 9 | 12 |
| Weight of silica (g/m²) | | | | 0 | 0.21 | 0.47 | 0.31 |
| Coating technique | | | | air knife | air knife | air knife | curtain |
| Gloss of fine paper (%) | | 4.6 | 6.8 | 7.5 | 4.5 | 2.8 | 3.9 |
| Offset printing | Ink drying times (min) | 230 | 260 | 80 | 78 | 27 | 35 |
| | Fine paper gloss after | 4.6 | 8.3 | 15.8 | 10.2 | 4.6 | 11.3 |
| | printing (%) | | | | | | |

| | | | Examples | | | | | |
|---|---|---|---|---|---|---|---|---|
| | | | 7 | 8 | 9 | 10 | 11 | 12 |
| Fine paper | | | Rives | Rives | Conqueror | Conqueror | Conqueror | Rives |
| | | | Tradition ® | Tradition ® | Velin ® | Velin ® | Velin ® | Tradition ® |
| Characteristics of | Texture | | natural + | natural + | natural | natural | natural | natural |
| the fine paper | | | forced | forced | | | | |
| | Weight (g/m²) | | 240 | 240 | 120 | 120 | 120 | 240 |
| | Bulk (cm³/g) | | 1.36 | 1.36 | 1.26 | 1.26 | 1.26 | 1.26 |
| | Bendtsen roughness | | 1370 | 1370 | 200 | 200 | 200 | 1370 |
| | (ml/min) | | | | | | | |
| | Bendtsen porosity | | 460 | 460 | 580 | 580 | 580 | 460 |
| | (ml/min) | | | | | | | |
| | Bekk smoothness (s) | | 2 | 2 | 21 | 21 | 21 | 2 |
| Treatment coating | | | YES | YES | YES | YES | YES | YES |
| Composition of the | Pigments | Silica | 7 | 7 | 7 | 8.7 | 13.1 | 13.1 |
| treatment coating | | Syloid | | | | | | |
| | | ED5 ® (%) | | | | | | |
| | | Calcium | (80% < | (80% < | (90% < | (80% < | (80% < | (80% < |
| | | Carbonates | 2 mm) | 2 mm) | 2 mm) | 2 mm) | 2 μm) | 2 μm) |
| | | (%) | 80.2 | 80.2 | 80.2 | 78.6 | 74.1 | 74.1 |
| | | Kaolin (%) | | | | | | |

| | Binder (%) | (styrene | (styrene | (styrene | (styrene | (styrene | (styrene |
|---|---|---|---|---|---|---|---|
| | | butadiene | butadiene | butadiene | butadiene | acrylic | acrylic |
| | | latex and | latex and | latex and | latex and | latex and | latex and |
| | | polyvinyl | polyvinyl | polyvinyl | polyvinyl | polyvinyl | polyvinyl |
| | | alcohol) | alcohol) | alcohol) | alcohol) | alcohol) | alcohol) |
| | | 11.7 | 11.7 | 11.7 | 11.7 | 11.8 | 11.8 |
| | Curing agent (%) | 0.4 | 0.4 | 0.4 | 0.4 | 0.4 | 0.4 |
| | Thickener (%) | (carboxyl | (carboxyl | (carboxyl | (carboxyl | (carboxyl | (carboxyl |
| | | methyl | methyl | methyl | methyl | methyl | methyl |
| | | cellulose) | cellulose) | cellulose) | cellulose) | cellulose) | cellulose) |
| | | 0.7 | 0.7 | 0.7 | 0.6 | 0.7 | 0.7 |
| | Surfactant (%) | | | | | | |
| Total weight of the coating (g/m²) | | 8.5 | 12.5 | 10 | 9 | 10 | 10 |
| Weight of silica (g/m²) | | 0.59 | 0.87 | 0.7 | 0.78 | 1.3 | 1.3 |
| Coating technique | | air knife | air knife | air knife | air knife | air knife | air knife |
| Gloss of fine paper (%) | | 2.6 | 3 | 3.1 | 2.6 | 3.6 | 3.3 |
| Offset printing | Ink drying times (min) | 7 | 6 | 8 | 5 | 4.5 | 4 |
| | Fine paper gloss after | 4.2 | 5.9 | 6.2 | 3.6 | 6.6 | 5 |
| | printing (%) | | | | | | |

1. Fine matt writing and/or printing paper, having a bulk greater than or equal to 1.10 cm³/g and including, on at least one of its faces, a coating comprising pigments and a binder, wherein the pigments comprise silica having particles with a mean diameter greater than or equal to 3 μm, and deposited at a quantity per unit area of the coating that is greater than 0.4 g/m² and less than 1.5 g/m², the paper having on said face a degree of gloss before printing that is less than or equal to 4% when measured at 75° using the Tappi®T480 standard.

2. Paper according to claim 1, wherein the coating includes other pigments selected from calcium carbonates, kaolins, titanium dioxide, talc, and mixtures thereof.

3. Paper according to claim 1, wherein the binder is selected from polyvinyl alcohols, styrene-butadiene copolymers, styrene-acrylic, and mixtures thereof.

4. Paper according to claim 1, wherein the silica is a porous amorphous synthetic silica.

5. Paper according to claim 1, wherein the weight of the coating on said face lies in the range 3 g/m² to 18 g/m².

6. Paper according to claim 1, wherein the layer is of thickness lies in the range 2 μm to 10 μm.

7. Paper according to claim 1, wherein the coating includes a thickener, a curing agent, and/or a surfactant.

8. Paper according to claim 1, wherein the particles of silica have a mean diameter greater than 6 μm.

9. Paper according to claim 1, wherein the particles of silica have a mean diameter lying in the range 3 μm to 20 μm.

10. Paper according to claim 1, wherein the mean diameter of the silica particles is greater than or equal to the thickness of the coating on said face.

11. Paper according to claim 1, wherein the quantity of silica in the coating lies in the range 6% to 15% by dry weight relative to the total dry weight of the coating.

12. Paper according to claim 1, wherein the weight of silica on said face lies in the range 0.5 g/m² to 1.2 g/m².

13. Paper according to claim 1, wherein it is made up of cellulose fibers and fillers presenting a quantity of less than 22% by dry weight relative to the total dry weight of the paper.

14. Paper according to claim 1, wherein it is textured or marked and includes patterns in relief or in recess, and wherein the coating modifies said texture of said face little or not at all.

15. Paper according to claim 1, wherein it has thickness lying in the range 0.1 mm to 0.5 mm, and/or weight lying in the range 100 g/m² to 300 g/m².

16. Paper according to claim 1, wherein it has Bendtsen roughness lying in the range 100 mL/min to 1500 mL/min, and/or Bendtsen porosity lying in the range 400 mL/min to 700 mL/min, and/or Bekk smoothness lying in the range 1 s to 30 s.

17. A method of preparing fine matt writing and/or printing paper according to claim 1, wherein it comprises the steps consisting in depositing the coating on at least one of the faces of the fine paper by a coating method of the contactless type.

18. Paper according to claim 1, which has a printing ink drying time of less than 20 min.
